(19) United States
(12) Patent Application Publication
(10) Pub. No.: US 2026/0102688 A1
(43) Pub. Date: Apr. 16, 2026

(54) SYSTEMS AND METHODS FOR ORCHESTRATING CARD GAMES

(71) Applicant: Aaron Jacob Levy, Winnetka, CA (US)

(72) Inventor: Aaron Jacob Levy, Winnetka, CA (US)

(21) Appl. No.: 19/357,826

(22) Filed: Oct. 14, 2025

Related U.S. Application Data
(60) Provisional application No. 63/706,427, filed on Oct. 11, 2024.

(51) Int. Cl. A63F 1/18; A63F 1/00; G07F 17/32

(52) U.S. Cl. CPC A63F 1/18; G07F 17/3293; A63F 2001/003; A63F 2001/005

(57) ABSTRACT

Systems and methods for orchestrating card games simulated using a computing system, the operations including dealing hole cards from a deck of playing cards to each player input position in a simulated environment, the hole cards including at least two cards, dealing, in response to a first electronic wager, at least two community cards from the deck, dealing, in response to a second electronic wager, a final community card from the deck, determining, in response to a third electronic wager, a winning player hand based on a ranking of a player hand of each remaining player input position, each player hand corresponding to a combination of cards from the hole cards and the community cards, and providing the player input position associated with the winning hand a payout, the payout being based on at least one of the first electronic wager, the second electronic wager, and the third electronic wager.

### CROSS-REFERENCE TO RELATED APPLICATIONS

The present application claims priority to and benefit of U.S. Provisional Patent Application No. 63/706,427, filed Oct. 11, 2024, and entitled “SYSTEM AND METHOD FOR ORCHESTRATING A CARD GAME,” the entirety of which is herein incorporated by reference.

### FIELD

The present disclosure relates to the field of electronic gaming systems. More particularly, to systems for orchestrating card games using simulated playing cards.

### BACKGROUND

Legalized games of chance are available in many states throughout the United States and in different countries worldwide. Some games can utilize a set of playing cards. Games of chance can include, for example, blackjack, Baccarat, Craps, etc. To attract and maintain patron interest, a gaming establishment in this industry typically offers a variety of different types of games including live games using a physical set of playing cards and electronic gaming systems that orchestrate games utilizing a simulated set of playing cards.

### BRIEF DESCRIPTION OF THE DRAWINGS

Some embodiments of the disclosure are herein described, by way of example only, with reference to the accompanying drawings. With specific reference now to the drawings in detail, it is stressed that the embodiments shown are by way of example and for purposes of illustrative discussion of embodiments of the disclosure. In this regard, the description taken with the drawings make apparent to those skilled in the art how embodiments of the disclosure may be practiced.

FIG. 1 is a schematic diagram illustrating a system for orchestrating a card game, according to some embodiments.

FIG. 2 is a block diagram illustrating a system, according to some embodiments.

FIG. 3 is a flow diagram illustrating a method for orchestrating a card game, according to some embodiments.

FIG. 4 is a flow diagram illustrating a method for orchestrating the card game, according to some embodiments.

FIG. 5 is a flow diagram illustrating a method for orchestrating the card game, according to some embodiments.

FIG. 6 is a block diagram illustrating an example computing system, according to some embodiments.

### DETAILED DESCRIPTION

Various embodiments of this disclosure relate to systems and methods for orchestrating card games in a virtual environment using a set of playing cards. The system can be a computing device including therein one or more components including, but not limited to, a processor and a memory. The memory can be a non-transitory computer readable media having stored thereon instructions executable by the processor to perform operations corresponding to orchestration of the card game including, but not limited to, dealing of hole cards to each player input position, receiving wagers from each player input position, dealing of community cards, determining a player hand of each player input position based on a combination of the hole cards and the community cards, determining a winning hand from the player hands of each remaining player input position, and distributing a payout to the player input position associated with the winning hand.

Based on one or more rules of the card game, the system can perform operations including orchestrating the card game, determine each player hand based on a combination of the respective hole cards and community cards, determine the winning hand, determine a payout to the player input position(s) having the winning hand(s), other operations, or any combination thereof. For example, the payout to the player input position having the winning hand may be a multiple of the first wager, second wager, third wager, or combination thereof, of the player input position. In another example, the payout to the player input position having the winning hand may be based on a combination of the first wager, second wager, and the third wager, or a portion thereof. In some examples, the payout to the player input position having the winning hand during a given round of play of the card game may be based on the total wagers received from the players. In some examples, a payout to the player input position for having the winning hand may have a transaction fee (e.g., “rake”) deducted from a total of the wagers received from the players during the given round of play. As used herein, the term “rake” refers to an amount by which the total wagers are reduced prior to distributing the payout to the winning hand(s), the amount of the rake being based on a predefined set of rules of the card game. For example, the rake may be calculated as a percentage of the total wagers from the players up to a maximum amount.

The system can orchestrate the card game in a simulated environment (e.g., virtual environment) using a simulated set of playing cards. The system may output data corresponding to the simulated environment to be displayed at a user interface associated with a corresponding player input position. The user interface may, for example, be displayed at a display device of the system or a display device of the user computing device. The system can orchestrate the card game using a deck of playing cards. The deck of playing cards can be a simulated deck of playing cards represented in the simulated environment. The deck of playing cards can be similar to or the same as a deck of playing cards typically used to play card games such as poker, blackjack, and the like. The deck of playing cards can include, for example, 52 cards including 4 different suits, with each suit including 13 cards having values ranging from 2 to ace (“A”). The suits can include spades, clubs, hearts, and diamonds. Stated another way, the 52 cards of the deck can include 4 suits corresponding to hearts, diamonds, clubs, and spades, and each suit in the deck of playing cards can have 13 cards including a 2, 3, 4, 5, 6, 7, 8, 9, 10, jack (“J”), queen (“Q”), king (“K”), and ace (“A”). It is to be appreciated that the suits and values in the deck of playing cards is not intended to be limiting, and the simulated deck of playing cards can include these suits and values and/or other suits and values. For example, the deck of playing cards can include these 4 suits or one or more different suits as representations. In another example, each suit of the deck of playing cards can have these values, different values, or any combination thereof.

The system may be in electronic communication with a user interface, the user interface being associated with a player input position. The player input position can be associated with a user of the system. The system can be configured to display the card game to the user interface associated with the player input position. The system can be configured to receive inputs from the player input position, or from the user associated with the player input position, at the user interface. In some embodiments, the system can include the user interface. In other embodiments, a computing device of the user in electronic communication with the system can include the user interface. The user computing device can be in electronic communication with the system through, for example, a network of the system.

The system can output one or more results of the card game to the user interface associated with the player input position. The results of the card game can include, but is not limited to, hole cards, community cards, wagers, player hands, winning hands, payout lists, other information of the card game, or any combination thereof, associated with the player input position, or associated with another player input position of the card game. For example, to determine the winning hand, the hole cards of the other player input positions can be revealed to the player input position at the user interface.

The system can be configured to orchestrate the card game with a player input position participating in the card game. To determine if the player hand is a winning hand, the player hand can be compared to one or more thresholds corresponding to a payout listing. The payout to the player input position being based on the cards of the player hand having a greater value than at least one of the threshold(s). For example, the player hand having a pair or better may result in a winning hand.

The system can be configured to orchestrate the card game with at least one player input position and a dealer position. In this regard, each player input position and the dealer can be dealt hole cards. To determine if a player hand associated with player input position is a winning hand, the player hand can be compared with the dealer hand. If the cards of the player hand associated with the player input position has a greater value than the cards of the dealer hand, the system can distribute a payout to the corresponding player input position. For example, the system can distribute a payout to a player input position based on the player input position having a three of a kind in their player hand and the dealer having two pairs in the dealer hand.

The system can be configured to orchestrate the card game with a plurality of player input positions participating in the card game. In some embodiments, for each deck of playing cards, the card game can be played by two, three, four, five, six, seven, eight, or more player input positions. In this regard, each player input position can be dealt hole cards. To determine the winning hand, a player hand associated with each player input position is compared with the other player hands associated with the other player input positions, and the player hand having the highest ranking based on the rules of the game is determined to be the winning hand. Should two or more of the player hands have the same highest ranking, the payout can be split between the corresponding two or more player input positions. In other embodiments, for each player input position, the system can determine a highest ranking hand and a lowest ranking hand based on a combination of the hole cards of the corresponding player input position and the community cards. In this regard, in some embodiments, the highest ranking player hand can receive a first payout and the lowest ranking player hand can receive a second payout. In some embodiments, different player input positions can receive the first and second payout based on the respective player input position having one of the highest and lowest ranking player hands. In other embodiments, the same player input position can receive the first and second payout based on the combination of hole cards of the player input position and the community cards making up the highest ranking and lowest ranking hands.

In some embodiments, a system for orchestrating a simulated card game can include a processor and a non-transitory computer readable media having stored therein instructions executable by the processor to perform operations including: deal hole cards from a deck of playing cards to each player input position in a simulated environment, the hole cards including at least two cards; deal, in response to a first electronic wager from at least two player input positions, at least two community cards from the deck; deal, in response to a second electronic wager from the at least two player input positions, a final community card from the deck; determine, in response to a third electronic wager from each remaining player input position, a winning player hand based on a ranking of a player hand of each remaining player input position, each player hand corresponding to a combination of cards from the hole cards and the community cards; and provide the player input position associated with the winning hand a payout, the payout being based on at least one of the first electronic wager, the second electronic wager, and the third electronic wager.

In some embodiments, each player input position can correspond to a user interface in electronic communication with the system.

In some embodiments, the hole cards of a given player input position is displayed on the corresponding user interface of the given player input position, and the hole cards of the given player input position is concealed on the corresponding user interfaces of the other player input positions until the winning hand is determined.

In some embodiments, the deck of playing cards is in a random arrangement.

In some embodiments, the operations can further include display the at least two community cards; and display the final community card, each of the community cards is displayed on a simulated gaming surface to the at least two player input positions participating in the card game.

In some embodiments, determining the winning player hand based on the ranking of the player hand of each remaining player input position can further include: display the hole cards of each remaining player input position, the hole cards of each remaining player input position being displayed on the simulated gaming surface.

In some embodiments, the simulated gaming surface further includes: a betting area associated with each player input position.

In some embodiments, the hole cards of each player input position include two cards, and the player hand of each player input position includes the hole cards of the respective player input position and the community cards.

In some embodiments, the hole cards of each player input position include four cards, and the player hand of each player input position includes a first hand, the first hand corresponding to a first set of cards having a highest rank based on one or more rules.

In some embodiments, the player hand of each player input position further includes a second hand, the second hand corresponding to a second set of cards having a lowest rank based on the one or more rules.

In some embodiments, the player hand of each player input position includes two hole cards, and a remainder of the player hand includes the community cards.

In some embodiments, the player hand includes two, three, or four of the hole cards, and a remainder of the player hand includes the community cards.

In some embodiments, a method for conducting a card game in an electronic gaming system, the method includes: obtaining, by the electronic gaming system, a deck of playing cards in a randomly shuffled arrangement; dealing, by the electronic gaming system, hole cards from a deck of playing cards to each player input position in a simulated environment, the hole cards including two cards from the deck; dealing, by the electronic gaming system in response to a first wager from at least two player input positions, at least two community cards from the deck; dealing, by the electronic gaming system in response to a second wager from the at least two player input positions, a final community card from the deck; determining, by the electronic gaming system in response to a third wager from each remaining player input position, a winning player hand based on a ranking of a player hand of each remaining player input position, each player hand corresponding to a combination of cards from the hole cards and the community cards; and providing, by the gaming system, the player input position associated with the winning hand a payout, the payout being based on at least one of the first wager, the second wager, and the third wager.

In some embodiments, the method further includes: display the at least two community cards to the at least two player input positions; and display the final community card to the at least two player input positions, each of the community cards is displayed on a simulated gaming surface to the at least two player input positions participating in the card game.

In some embodiments, determining the winning player hand based on the ranking of the player hand of each remaining player input position further includes: display the hole cards of each remaining player input position, the hole cards of each remaining player input position is displayed on the simulated gaming surface.

In some embodiments, the hole cards dealt to each player input position includes four cards from the deck.

In some embodiments, determining the winning player hand based on the ranking of the player hand of each remaining player input position further includes: determine a first hand for each remaining player input position, the first hand corresponding to a first set of cards having a highest rank based on one or more rules.

In some embodiments, determining the winning player hand based on the ranking of the player hand of each remaining player input position further includes: determine a second hand for each remaining player input position, the first hand corresponding to a second set of cards having a lowest rank based on the one or more rules.

In some embodiments, the player hand of each player input position includes two hole cards, and a remainder of the player hand of each player input position includes the community cards.

In some embodiments, the player hand of each player input position includes two, three, or four of the hole cards, and a remainder of the player hand of each player input position includes the community cards.

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

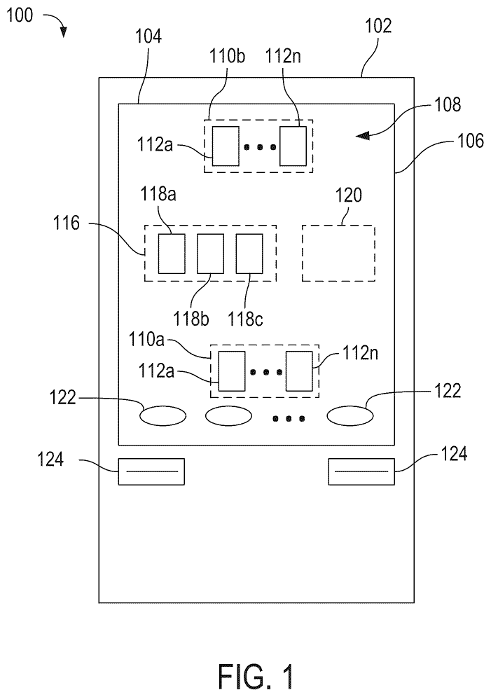

FIG. 1 is a schematic diagram illustrating a system 100 orchestrating a card game, according to some embodiments.

System 100 can include an interface 104 (e.g., user interface). The system 100 can display one or more results of the card game at the interface 104. In some embodiments, the system 100 can display a simulated environment 106 at the interface 104. The simulated environment 106 displayed at the interface 104 can include a simulated gaming surface 108. The simulated environment 106 displayed at the interface 104 can include an area 110 for hole cards 112 of each corresponding player input position to be dealt by an orchestrator. The simulated environment 106 displayed at the interface 104 can include an area 116 for community cards 118 to be dealt by the orchestrator. The simulated environment 106 displayed at the interface 104 can include a wager area 120. In some embodiments, the simulated environment 106 displayed at the interface 104 can include a payout listing (not shown).

System 100 can include an input component 122. In some embodiments, the input component 122 can be displayed at the interface 104. In some embodiments, the input component 122 can send data to the interface 104 to cause the interface 104 to display one or more elements. In some embodiments, the input component 122 of system 100 can receive inputs from a respective player input position based on a user interaction with the corresponding one or more elements at the interface 104, each element corresponding to an instruction or set of instructions that the input component 122 can receive as an action of the respective player input position. For example, the input component 122 of system 100 can provide data to a user interface 104 to cause the user interface 104 to display one or more elements representative of buttons, and the display device can have sensors configured to detect a user input corresponding to a user interaction with the one or more buttons at the user interface 104. In some examples, the system 100 may include one or more physical buttons including sensors, which can be actuated when pressed by a user, and the sensor can send an electrical signal to the input component 122 to indicate the user interaction and the input component 122 can determine the user input based on the electrical signals received from the sensors. The user associated with the player input position can perform one or more actions in the card game based on inputs at the user interface 104 to the input component 122. For example, the input component 122 can correspond to user actions for the card game including, but is not limited to, providing an ante or blinds, making a wager, calling a wager, increasing a wager, folding, ending the game, adding or withdrawing electronic funds associated with the player input position, other actions associated with the interaction with the game, or any combination thereof.

System 100 can include an input component 124. In some embodiments, the input component 124 can be displayed at the interface 104. In other embodiments, the input component 124 can be located on the system 100. In some embodiments, the input component 124 can be configured to receive a user input and obtain a user account based on an input. For example, the input component 124 can be a card reader for identifying a user profile based on reading a players card and associating the user profile with the player input position. In some embodiments, the input component 124 can be configured to receive a user input and associate electronic funds with the player input position based on the input. For example, the input component 124 can be a coin input, bill reader, coupon reader, credit card reader, and the like.

In some embodiments, the simulated gaming surface 108 can include one area 110 associated with the player input position playing the game. In some embodiments, the simulated gaming surface 108 can include an area 110 associated with each player input position in the card game. For example, the simulated gaming surface 108 can include two or more player input positions corresponding to two or more users participating in the card game.

In addition, each area 110 can include hole cards 112 dealt to the corresponding player input position. In some embodiments, the hole cards 112 can include two cards. In other embodiments, the hole cards 112 can include four cards. During the card game, the player hand can include a combination of the hole cards and the community cards, as will be further described herein.

Referring to FIG. 1, the simulated gaming surface 108 includes area 110a and area 110b. The area 110a can be associated with a first player input position. The area 110b can be associated with a second player input position. In some embodiments, the area 110b can be associated with a dealer. In other embodiments, the area 110b can be associated with another user playing the card game. For example, the area 110b can be for a second player input position playing the card game at a computing device of a user external to system 100 and associated with the second player input position. Each player input position participating in the card game can be dealt hole cards 112a to 112n from a simulated deck of playing cards (not shown) to a corresponding area 110a, 110b associated with the corresponding player input position. It is to be appreciated that although the simulated gaming surface 108 shows having area 110a and area 110b, the simulated gaming surface 108 can include one area 110 associated with one player input position or can include a plurality of areas 110 associated with a plurality of player input positions.

In addition, the simulated gaming surface 108 can include area 116 for community cards 118a, 118b, 118c. The community cards 118a, 118b, 118c can be dealt in one or more stages to area 116, which is then available to each player input position participating in the game to make up the player hand of each remaining player input position. In some embodiments, the system 100 can deal, in response to a first wager, at least two community cards from the deck, and the system 100 can deal, in response to a second wager, a final community card from the deck. In some embodiments, a player hand can be a combination of the hole cards 112a, 112b from the area 110a, 110b associated with the player input position of the user and the community cards 118a, 118b, and 118c.

The simulated gaming surface 108 can include wager area 120. In some embodiments, the wager area 120 can be associated with a certain player input position. For example, the wager area 120 can associated with area 110a. In other embodiments, the wager area 120 can be for storing the wagers made by each of the player input positions playing that round of the card game.

It is to be appreciated that the configuration of the simulated environment 106 and the simulated gaming surface 108 is exemplary and not intended to be limiting, and can include these and other configurations in accordance with the present disclosure.

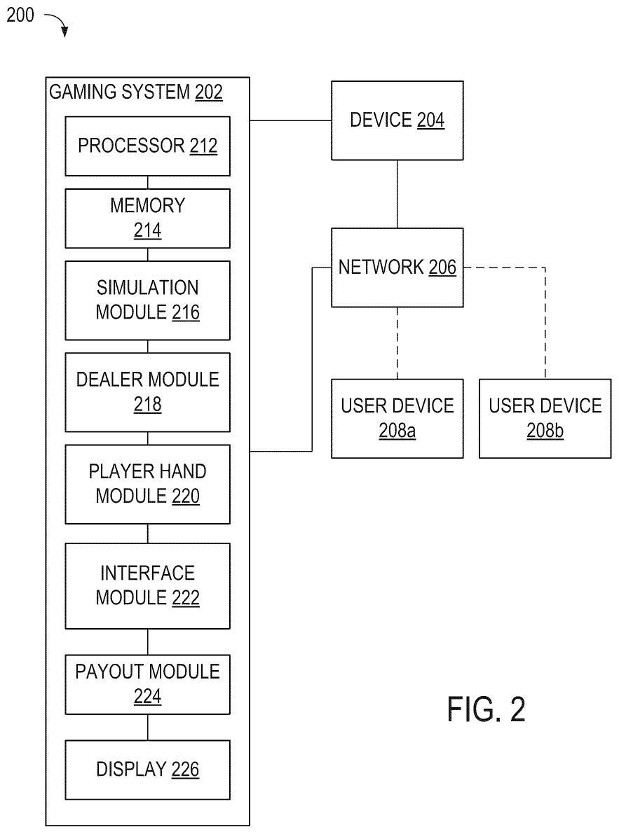

FIG. 2 is a block diagram illustrating a system 200, according to some embodiments.

System 200 includes gaming system 202, device 204, network 206. The gaming system 202 can include one or more functional modules 216, 218, 220, 222, and 224 for orchestrating the card game. The device 204 can include therein a memory (not shown) having stored therein instructions for orchestrating the card game. In some embodiments, the device 204 can have stored in the memory instructions for one or more of the functional modules 216, 218, 220, 222, and 224 used by gaming system 202 for orchestrating the card game. In some embodiments, the device 204 can have stored in the memory instructions for the rules of the card game. In some embodiments, the device 204 can have stored in the memory instructions for the payout list. In some embodiments, the device 204 can have stored in the memory instructions for arranging the deck of playing cards in the random arrangement. The network 206 can enable the gaming system 202 to be in electronic communication with one or more other devices in the system 100. In some embodiments, the gaming system 202 can be in electronic communication with device 204 through the network 206.

In some embodiments, the system 200 can include the system 100 embodied by one or more of the functional modules at gaming system 202.

In some embodiments, the system 100 can include a plurality of user devices 208 (two such user devices 208a, 208b are shown). In some embodiments, the gaming system 202 can be in electronic communication with the plurality of user devices 208 through the network 206. It is to be appreciated that although not shown in the figures, the system 200 can include one or more other devices in electrical connection with the system 202 via network 206 for orchestrating the card game with one or more other computing devices of the system 200 such as, for example, the user devices 208. It is also to be appreciated that the number of computing devices that can be connected to system 200 and playing the card game using system 200 is not intended to be limiting and that the system 200 can be scalable so as to include any number of computing devices any number of card games. For example, hundreds, thousands, millions, tens of millions, or more respective devices can be playing the card game using system 200.

The gaming system 202 includes a processor 212 and a non-transitory computer readable memory 214 that contains instructions that, when executed by the processor 212, causes the gaming system 202 to perform one or more steps, processes, methods, operations, etc. described herein with respect to the gaming system 202. The gaming system 202 can include one or more functional modules embodied in the memory. The functional modules can include a simulation module 216, dealer module 218, player hand module 220, interface module 222, and payout module 224. In some embodiments, the gaming system 202 can include a display 226. In some embodiments, the display 226 can display the interface 104 of a corresponding player input position to a user to enable the user to participate in the card game.

The simulation module 216 can be configured to provide the simulated environment such as, for example, simulated environment 106, to be displayed at the interface 104. In some embodiments, the simulation module 216 can be configured to provide the simulated gaming surface such as, for example, simulated gaming surface 108 in the simulated environment 106. In some embodiments, the simulation module 216 can be configured to provide the simulated deck of playing cards (not shown). In some embodiments, the simulation module 216 can be configured to arrange (i.e., shuffle) the deck of playing cards in a random arrangement before distributing the deck of playing cards to each player input position at the start of a round of the card game.

In some embodiments, the simulation module 216 can be configured to display the playing cards on the simulated gaming surface. In some embodiments, the simulation module 216 can be configured to display one or more objects on the simulated gaming surface. In some embodiments, the simulation module 216 can display objects including, but not limited to, hole cards, community cards, burn cards, wager areas, pots, payout lists, player inputs, player input positions, other objects related to the card game, or any combination thereof. In some embodiments, the simulation module 216 can be configured to display the hole cards of a given player input position in the face up position to display the value of the hole cards at the interface 104 associated with the given player input position, while simultaneously displaying the hole cards of the given player input position in the face down position to conceal the value of the hole cards at the other interfaces 104 associated with the other player input positions until such time when the player hands are revealed to the other player input positions.

The dealer module 218 can be configured to serve as the dealer of the card game and orchestrate the card game based on one or more rules. The dealer module 218 can be configured to deal cards to each player input position, deal community cards, receive wagers, determine player hands for each player input position based on the hole cards of the respective player input position and the community cards, determine a winning hand, and distribute a payout(s) to the winning hand(s) based on the rules of the card game. For example, the dealer module 218 can accept a wager from each participating player input position and can deal hole cards from the deck to each participating player input position. For example, the dealer module 218 can, in response to accepting a wager(s) from each participating player input position, deal community cards from the deck to a community area in the simulated gaming surface. In another example, the dealer module 218 can, during a wagering stage, determine that the wager(s) of each participating player input position matches the wager(s) of the other participating player input positions, before continuing with orchestration of the card game. In yet another example, the dealer module 218 can identify, during the wagering stage, that the wager(s) of a participating player input position does not match the wager(s) of the other participating player input positions and can determine that the participating player input position has wagered all the electronic funds in their corresponding playing area or that the participating player input position has folded their hole cards and is no longer participating in the card game, before continuing with orchestration of the card game.

The player hand module 220 can be configured to determine the player hand of each participating player input position. The player hand module 220 can determine a player hand from the hole cards associated with the player input position and the community cards. In some embodiments, each player input position can be dealt two hole cards, the community area can be dealt a total of three hole cards, and the player hand can include a combination of the two hole cards and the three community cards. In some embodiments, each player input position can be dealt two to four hole cards, and a player hand can include two of the hole cards and a remainder of the player hand including the community cards. In some embodiments, each player input position can be dealt two to four hole cards, and a player hand can include three of the hole cards and a remainder of the community cards can make up a remainder of the player hand. For example, the player hand can be a combination of three of the four hole cards and two of the three community cards. In some embodiments, each player input position can be dealt two to four hole cards, and the player hand can include four of the hole cards and the community cards can make up a remainder of the player hand. For example, the player hand can include the four hole cards and one of the community cards. In another example, the player hand can include the four hole cards and two of the community cards. In yet another example, the player hand can include the four hole cards and the three community cards.

The player hand module 220 can be configured to determine a winning hand amongst the player hands of each participating player input position. In some embodiments, the player hand module 220 can be configured to rank the player hands of each participating player input position and the player hand module 220 can determine the winning hand based on the ranking. In some embodiments, the winning hand can be the player hand having a highest rank relative the other player hands. In some embodiments, the value of the 13 cards from lowest to highest rank can be: 2, 3, 4, 5, 6, 7, 8, 9, 10, J, Q, K, A, with J, Q, and K having a face value of 10, and A having a value of 11 or the A having a value of 1 when the A beings with a straight or straight flush. In some embodiments, the value of a combination of the five cards making up a player hand from lowest to highest rank can be: high card, pair, two pair, three of a kind, straight, flush, full house, four of a kind, straight flush, and royal flush. For example, a first player input position having a straight is the winning hand over a second player input position having two pairs. If none of the player hands of the participating player input positions has a pair or higher, the winning hand can be the player hand having a combination of the five highest value cards. For example, a first player input position with a five-card combination player hand of 2, 4, 9, J, A is the winning hand over a second player input position with a five-card combination player hand of 3, 5, 10, J, Q due to the first player input position hand including a higher value card (e.g., A) than the second player input position hand (e.g., Q).

In some embodiments, the player hand module 220 can be configured to determine a first hand and a second hand for each player input position based on the hole cards associated with the player input position and the community cards. In some embodiments, the first hand can be a combination of cards from the hole cards and the community cards that has the highest rank as described above. In some embodiments, the second hand can be a combination of five cards from the hole cards and the community cards that make a qualifying five-card low hand. In some embodiments, to be a qualifying low hand, the player hand can be an 8 high or lower. That is, the player hand cannot contain a card with a value of 9 or higher, including 9, 10, J, Q, K, and A, unless the A makes up the low card of the straight or straight flush. For example, the lowest possible five-card player hand is A, 2, 3, 4, and 5. In some embodiments, if multiple player input positions have qualifying five-card low hands, the winning low hand can be determined by the player hand module 220 by comparing the highest card of each player hand, the lowest high card being the winning hand. For example, for the second hand, a player hand including 7, 6, 4, 3, and A is the winning hand over a player hand including 8, 6, 4, 3, and 2.

The interface module 222 can be configured to send data for display at interface 104 and receive data corresponding to user inputs from the interface 104. For example, the interface module 222 may obtain data corresponding to the simulated gaming surface 108 from the simulation module 216 for display at the interface 104 including the objects on the simulated gaming surface 108. The interface module 222 can also receive user inputs. In some embodiments, the interface module 222 can receive inputs provided by the user to the interface 104. For example, the interface module 222 can receive inputs corresponding to making wagers, calling wagers, raising wagers, checking, folding, other actions that can be made by the player input position, or any combination thereof.

The payout module 224 can be configured to determine a payout to be distributed to a player input position having a winning hand. For example, if a player input position has a winning hand over a dealer, the payout module 224 can provide the dealer module 218 instructions to distribute a payout to the player input position based on the wagers made by the player input position. In another example, if a player input position has a winning hand over the other player input positions, the payout module 224 can provide the dealer module 218 instructions to distribute a payout to the player input position based on the wagers made by the other player input positions and the player input position.

In some embodiments, the payout module 224 can be configured to determine a payout to each player input position having a winning hand. For example, if a first player input position and a second player input position each have a winning hand or equal rank, a payout can be distributed to each of the first player input position and the second player input position from the total wagers of all the player input positions based on the wagers of each of the first player input position and second player input position.

It is to be appreciated that the gaming system 202 can include one or more of the functional modules 216, 218, 220, 222, and 224, or the gaming system 202 can include one or more other functional modules to enable the gaming system 202 to orchestrate the card game in accordance with the present disclosure.

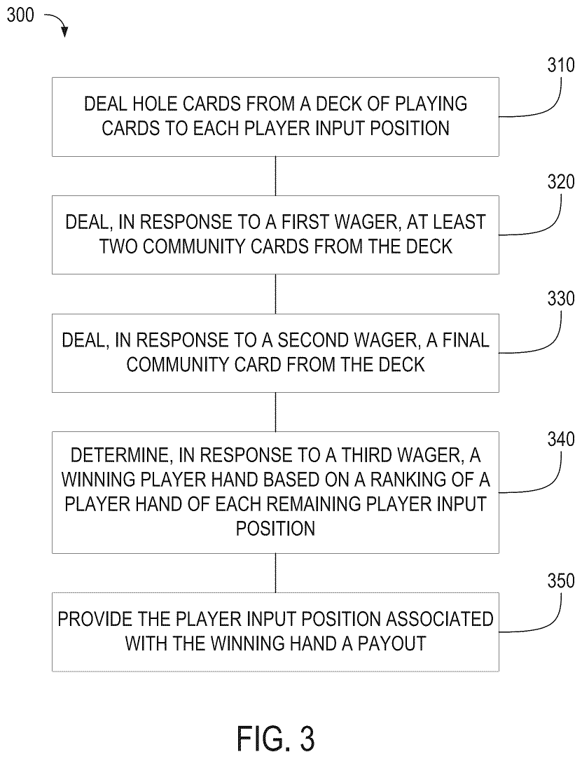

FIG. 3 is a flow diagram illustrating a method 300 for orchestrating a card game, according to some embodiments. In some embodiments, the method 300, or one or more portions thereof, can be performed by the system 100. In some embodiments, the method 300, or one or more portions thereof, can be performed by the functional modules in gaming system 202 in conjunction with device 204, network 206, user devices 208, or any combination thereof, and thus may be computer implemented.

At 310, the method 300 includes dealing hole cards from a deck of playing cards to each player input position in a simulated environment. In some embodiments, the hole cards can include at least two cards. In some embodiments, the deck of playing cards is in a random arrangement.

In some embodiments, the simulated environment can include a simulating gaming surface upon which the playing cards can be dealt. In some embodiments, for each participating player input position, the simulated gaming surface includes an area for the hole cards associated with a respective player input position. In some embodiments, the simulated gaming surface can include a betting area associated with each player input position. In some embodiments, the simulated gaming surface can include an area for community cards. In some embodiments, the simulated gaming surface can include an area where the wagers from each participating player input position is stored until the winning hand is determined.

In some embodiments, a player input position can correspond to a user interface in electronic communication with the gaming system. In other embodiments, each player input position can correspond to a user interface in electronic communication with the gaming system. In some embodiments, the hole cards of a given player input position can be displayed on the corresponding user interface of the given player input position, and the hole cards of the given player input position can be concealed on the corresponding user interfaces of the other player input positions until the winning hand is determined.

At 320, the method 300 includes dealing at least two community cards from the deck. In some embodiments, the at least two community cards can be dealt in response to a first wager from at least two player input positions. In some embodiments, the method 300 can include dealing two community cards from the deck, the two community cards being dealt in response to a first wager from participating player input position.

In some embodiments, the first wager can be obtained from each participating player input position. For example, the first wager can be a matching wager value from each participating player input position. In some embodiments, the first wager can include one or more first wagers until the one or more first wagers from each participating player input position matches the first wager from the other participating player input positions. In some embodiments, a given player input position may not have enough electronic funds in reserve to match the first wager of the other remaining player input positions. In this regard, in some embodiments, the dealer can receive a first wager from the given player input position in the amount remaining in their reserve and then deal the at least two community cards, the given player input position being eligible for a payout proportionate to their total wager that is matched by the other participating player input positions.

At 330, the method 300 includes dealing a final community card from the deck. In some embodiments, the final community card is dealt from the deck in response to a second wager from the at least two player input positions. In some embodiments, the final community card is a third community card. In some embodiments, the final community card is dealt from the deck in response to a second wager from the participating player input positions.

In some embodiments, the second wager can be obtained from each participating player input position. For example, the second wager can be a matching wager value from each participating player input position. In some embodiments, the second wager can include one or more second wagers until the one or more second wagers from each participating player input position matches the second wager from the other participating player input positions. In some embodiments, a given player input position may not have enough electronic funds in reserve to match the second wager of the other remaining player input positions. In this regard, in some embodiments, the dealer can receive a second wager from the given player input position in the amount remaining in their reserve and then deal the final community card, the given player input position being eligible for a payout proportionate to their total wager that is matched by the other participating player input positions.

At 340, the method 300 includes determining a winning player hand based on a ranking of a player hand of each remaining player input position. In some embodiments, the winning player hand can be determined in response to a third wager from each remaining player input position that is participating in the hand. In some embodiments, each player hand can correspond to a combination of cards from the hole cards and the community cards.

In some embodiments, the third wager can be obtained from each participating player input position. For example, the third wager can be a matching wager value from each participating player input position. In some embodiments, the third wager can include one or more third wagers until the one or more third wagers from each participating player input position matches the third wager from the other participating player input positions. In some embodiments, a given player input position may not have enough electronic funds in reserve to match the third wager of the other remaining player input positions. In this regard, in some embodiments, the dealer can receive a third wager from the given player input position in the amount remaining in their reserve and then determine the winning hand, the given player input position being eligible for a payout proportionate to their total wager that is matched by the other participating player input positions.

In some embodiments, the hole cards of each player input position can include two cards. In some embodiments, the player hand of each player input position includes the two hole cards of the respective player input position and the three community cards. In some embodiments, the player hand of each player input position includes the hole cards of the respective player input position, and a remainder of the player hand is made up of the community cards. In some embodiments, the hole cards of each player input position can include two, three, or four hole cards. In some embodiments, the player hand of each player input position includes two, three, or four of the hole cards, and a remainder of the player hand includes the community cards.

At 350, the method 300 includes providing the player input position associated with the winning hand a payout. In some embodiments, the payout can be based on at least one of the first wager, the second wager, and the third wager. In some embodiments, the payout can be a total of the first wager, second wager, and third wager from each participating player input position. In some embodiments, the payout can be a total of the first wager, second wager, and third wager from each participating player input position after having a rake taken from the total.

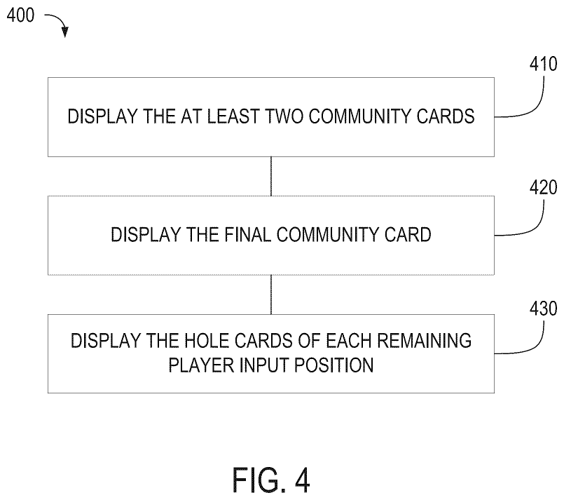

FIG. 4 is a flow diagram illustrating a method 400 for orchestrating the card game, according to some embodiments. the method 400 can be an embodiment of operation 320, 330, 340, or 350 of method 300 in FIG. 3. The method 400, or one or more portions thereof, can be performed by the functional modules of gaming system 202 in conjunction with device 204, network 206, user devices 208, or any combination thereof, and thus may be computer implemented.

At 410, the method 400 includes displaying the at least two community cards. At 420, the method 400 includes displaying the final community card. In some embodiments, each of the community cards can be displayed on a simulated gaming surface of the simulated environment at an area for the community cards. In some embodiments, the community cards can be displayed on a simulated gaming surface to the at least two player input positions participating in the card game.

In some embodiments, at 430, the method 400 can include displaying the hole cards of each remaining player input position. In some embodiments, the hole cards of each remaining player input position is displayed on the simulated gaming surface. In some embodiments, the value of the hole cards can be displayed to the corresponding player input position at the user interface while the value of the hole cards is concealed from the other player input positions until such a time as the winning hand is revealed.

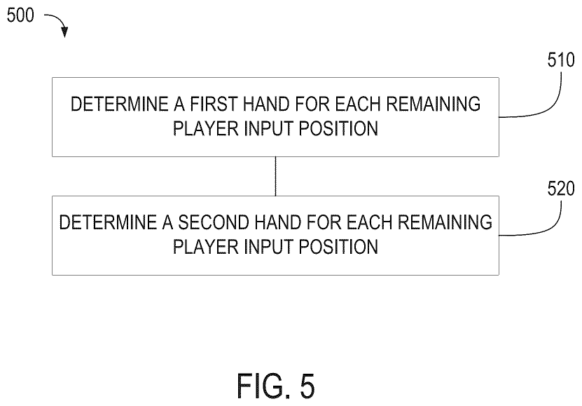

FIG. 5 is a flow diagram illustrating a method 500 for orchestrating the card game, according to some embodiments.

At 510, the method 500 includes determining a first hand for each remaining player input position. In some embodiments, the first hand for each remaining player input position can correspond to a first set of cards having a highest rank based on the rules of the gaming system orchestrating the card game. In some embodiments, the hole cards for each participating player input position can include two cards and the first hand can correspond to a first set of cards including the two hole cards and three community cards having a highest rank based on the rules of the gaming system. In other embodiments, the hole cards of each player input position can include four cards, and the first hand can correspond to a first set of cards including two, three, or four of the hole cards and a remainder of the player hand being made up of the community cards such that the first hand has the highest rank based on the rules of the gaming system.

In some embodiments, the player hand of each player input position can further include a second hand. In some embodiments, the second hand can correspond to a second set of cards having a lowest rank based on the rules of the gaming system orchestrating the card game. In some embodiments, to quality as the second hand, the highest card in the player hand can be an 8. In some embodiments, the hole cards for each participating player input position can include two cards and the second hand can correspond to a second set of cards including the two hole cards and three community cards having a lowest rank based on the rules of the gaming system. In other embodiments, the hole cards of each player input position can include four cards, and the second hand can correspond to a second set of cards including two, three, or four of the hole cards and a remainder of the player hand being made up of the community cards such that the second hand has the lowest rank based on the rules of the gaming system.

In some embodiments, the winning hand can include one or more winning hands based on one or more sets of rules simultaneously applied to the card game by the gaming system. In some embodiments, the winning hand can include a first winning hand, a second winning hand, a third winning hand, a fourth winning hand, or any combination thereof. In some embodiments, the first winning hand can be a player hand having a highest five card hand made up of the hole cards and the community cards. In some embodiments, the first winning hand can be a player hand having a highest five card hand made up of two hole cards and three community cards. In some embodiments, the second winning hand can be a player hand having a highest five card hand made up of two of the four hole cards and the three community cards. In some embodiments, the third winning hand can be a player hand having a lowest qualifying five card hand made up of two of the four hole cards and the three community cards. In some embodiments, the fourth winning hand can be a player hand having a highest five card hand made up of two, three, or four of the hole cards and a remainder made up of the community cards. In some embodiments, the fifth winning hand can be a player hand having a lowest qualifying five card hand made up of two, three, or four of the hole cards and a remainder made up of the community cards.

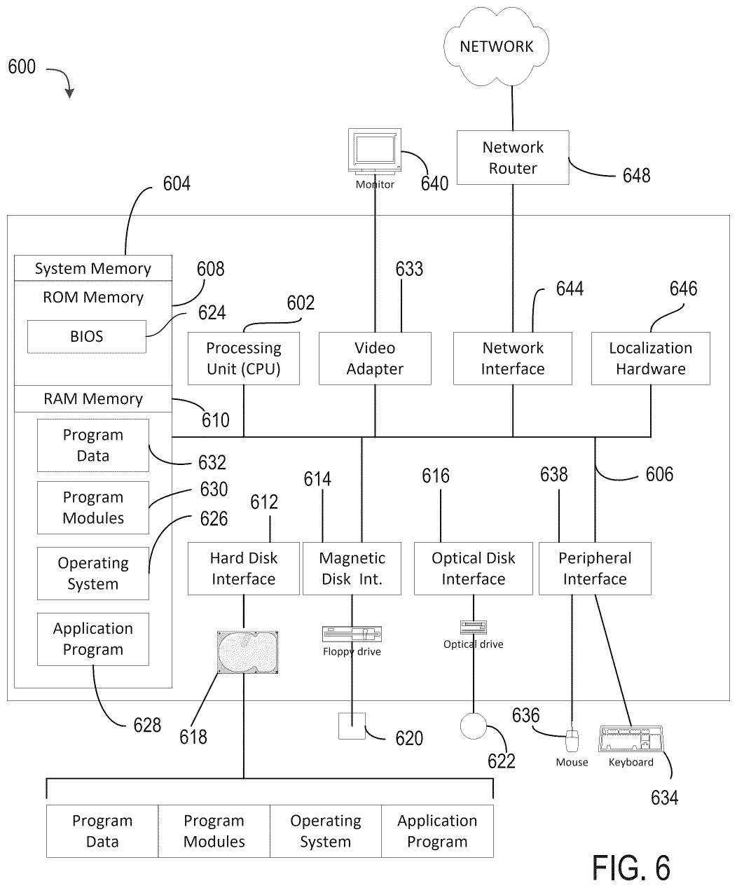

FIG. 6 is a block diagram illustrating an example computing system 600, according to some embodiments.

The computing system 600 can be, for example, a desktop computer, laptop, smartphone, tablet, or any other such device having the ability to execute instructions, such as those stored within a non-transient, computer-readable medium. Furthermore, while described and illustrated in the context of a single computing system 600, those skilled in the art will also appreciate that the various tasks described hereinafter may be practiced in a distributed environment having multiple computing systems 600 linked via a local or wide-area network in which the executable instructions may be associated with and/or executed by one or more of multiple computing systems 600.

In its most basic configuration, computing system environment 600 typically includes at least one processing unit 602 and at least one memory 604, which may be linked via a bus 606. Depending on the exact configuration and type of computing system environment, memory 604 may be volatile (such as RAM 610), non-volatile (such as ROM 608, flash memory, etc.) or some combination of the two. Computing system environment 600 may have additional features and/or functionality. For example, computing system environment 600 may also include additional storage (removable and/or non-removable) including, but not limited to, magnetic or optical disks, tape drives and/or flash drives. Such additional memory devices may be made accessible to the computing system environment 600 by means of, for example, a hard disk drive interface 612, a magnetic disk drive interface 614, and/or an optical disk drive interface 616. As will be understood, these devices, which would be linked to the system bus 606, respectively, allow for reading from and writing to a hard disk 618, reading from or writing to a removable magnetic disk 620, and/or for reading from or writing to a removable optical disk 622, such as a CD/DVD ROM or other optical media. The drive interfaces and their associated computer-readable media allow for the nonvolatile storage of computer readable instructions, data structures, program modules and other data for the computing system environment 600. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer readable instructions, data structures, program modules or other data. Any such computer storage media may be part of computing system environment 600.

A number of program modules may be stored in one or more of the memory/media devices. For example, a basic input/output system (BIOS) 624, containing the basic routines that help to transfer information between elements within the computing system environment 600, such as during start-up, may be stored in ROM 608. Similarly, RAM 610, hard drive 618, and/or peripheral memory devices may be used to store computer executable instructions comprising an operating system 626, one or more applications programs 628, other program modules 630, and/or program data 632. Still further, computer-executable instructions may be downloaded to the computing environment 600 as needed, for example, via a network connection. The applications programs 628 may include, for example, a browser, including a particular browser application and version, which browser application and version may be relevant to determinations of correspondence between communications and user URL requests, as described herein. Similarly, the operating system 626 and its version may be relevant to determinations of correspondence between communications and user URL requests, as described herein.

An end-user may enter commands and information into the computing system environment 600 through input devices such as a keyboard 634 and/or a pointing device 636. While not illustrated, other input devices may include a microphone, a joystick, a game pad, a scanner, etc. These and other input devices would typically be connected to the processing unit 602 by means of a peripheral interface 638 which, in turn, would be coupled to bus 606. Input devices may be directly or indirectly connected to processor 602 via interfaces such as, for example, a parallel port, game port, firewire, or a universal serial bus (USB). To view information from the computing system environment 600, a monitor 640 or other type of display device may also be connected to bus 606 via an interface, such as via video adapter 633. In addition to the monitor 640, the computing system environment 600 may also include other peripheral output devices, not shown, such as speakers and printers.

The computing system environment 600 may also utilize logical connections to one or more computing system environments. Communications between the computing system environment 600 and the remote computing system environment may be exchanged via a further processing device, such a network router 648, that is responsible for network routing. Communications with the network router 648 may be performed via a network interface component 644. Thus, within such a networked environment, e.g., the Internet, World Wide Web, LAN, or other like type of wired or wireless network, it will be appreciated that program modules depicted relative to the computing system environment 600, or portions thereof, may be stored in the memory storage device(s) of the computing system environment 600.

The computing system environment 600 may also include localization hardware 646 for determining a location of the computing system environment 600. In embodiments, the localization hardware 646 may include, for example only, a GPS antenna, an RFID chip or reader, a WiFi antenna, or other computing hardware that may be used to capture or transmit signals that may be used to determine the location of the computing system environment 600. Data from the localization hardware 646 may be included in a callback request or other user computing device metadata in the methods of this disclosure.

The computing system, or one or more portions thereof, may embody a user computing device 208, in some embodiments. Additionally, or alternatively, some components of the computing system 600 may embody the gaming system 202 and/or device 204. For example, the functional modules 216 218, 220, 222, and 224 may be embodied as program modules 630. For example, the simulation module 216 may be embodied as program modules 630.

In some embodiments, a system for playing a card game includes a processor; a non-transitory computer readable media having stored therein instructions executable by the processor to perform operations corresponding to a dealer of the card game, the operations including deal hole cards from a deck of playing cards to each player input position in a simulated environment, the hole cards including at least two cards; deal, in response to a first wager from at least two player input positions, at least two community cards from the deck; deal, in response to a second wager from the at least two player input positions, a final community card from the deck; determine, in response to a third wager from each remaining player input position, a winning player hand based on a ranking of a player hand of each remaining player input position, each player hand corresponding to a combination of cards from the hole cards and the community cards; and provide the player input position associated with the winning hand a payout, the payout being based on at least one of the first wager, the second wager, and the third wager.

In some embodiments, each player input position corresponding to a user interface in electronic communication with the system.

In some embodiments, one of the player input positions corresponding to the dealer.

In some embodiments, the hole cards of a given player input position is displayed on the corresponding user interface of the given player input position. In some embodiments, the hole cards of the given player input position is concealed on the corresponding user interfaces of the other player input positions until the winning hand is determined.

In some embodiments, the deck of playing cards is in a random arrangement.

In some embodiments, the operations further includes display the at least two community cards; and display the final community card, each of the community cards is displayed on a simulated gaming surface to the at least two player input positions participating in the card game.

In some embodiments, determining the winning player hand based on a ranking of the player hand of each remaining player input position further includes display the hole cards of each remaining player input position, the hole cards of each remaining player input position is displayed on the simulated gaming surface.

In some embodiments, the simulated gaming surface further includes a betting area associated with each player input position.

In some embodiments, the hole cards of each player input position includes two cards, and the player hand of each player input position includes the hole cards of the respective player input position and the community cards.

In some embodiments, the hole cards of each player input position includes four cards, and the player hand of each player input position includes a first hand, the first hand corresponding to a first set of cards having a highest rank based on one or more rules.

In some embodiments, the player hand of each player input position further includes a second hand, the second hand corresponding to a second set of cards having a lowest rank based on the one or more rules.

In some embodiments, the player hand of each player input position includes two hole cards, and a remainder of the player hand includes the community cards.

In some embodiments, the player hand includes two, three, or four of the hole cards, and a remainder of the player hand includes the community cards.

In some embodiments, a method for conducting a card game on a gaming system, the method includes obtaining, by the gaming system, a deck of playing cards in a randomly shuffled arrangement; dealing, by the gaming system, hole cards from a deck of playing cards to each player input position in a simulated environment, the hole cards including two cards from the deck; dealing, by the gaming system in response to a first wager from at least two player input positions, at least two community cards from the deck; dealing, by the gaming system in response to a second wager from the at least two player input positions, a final community card from the deck; determining, by the gaming system in response to a third wager from each remaining player input position, a winning player hand based on a ranking of a player hand of each remaining player input position, each player hand corresponding to a combination of cards from the hole cards and the community cards; and providing, by the gaming system, the player input position associated with the winning hand a payout, the payout being based on at least one of the first wager, the second wager, and the third wager.

In some embodiments, the method further includes displaying the at least two community cards to the at least two player input positions; and displaying the final community card to the at least two player input positions, each of the community cards is displayed on a simulated gaming surface to the at least two player input positions participating in the card game.

In some embodiments, determining the winning player hand based on a ranking of the player hand of each remaining player input position further includes displaying the hole cards of each remaining player input position, the hole cards of each remaining player input position is displayed on the simulated gaming surface.

In some embodiments, the hole cards of each player input position includes four cards from the deck.

In some embodiments, determining the winning player hand based on the ranking of the player hand of each remaining player input position further includes determining a first hand for each remaining player input position, the first hand corresponding to a first set of cards having a highest rank based on one or more rules.

In some embodiments, determining the winning player hand based on the ranking of the player hand of each remaining player input position further includes determining a second hand for each remaining player input position, the first hand corresponding to a second set of cards having a lowest rank based on the one or more rules.

In some embodiments, the player hand of each player input position includes two hole cards, and a remainder of the player hand of each player input position includes the community cards.

In some embodiments, the player hand of each player input position includes two, three, or four of the hole cards, and a remainder of the player hand of each player input position includes the community cards.

In some embodiments, a non-transitory computer readable media having stored therein instructions executable by a processor of a system to perform operations corresponding to dealing a card game, the operations includes deal hole cards from a deck of playing cards in a random arrangement to each player input position in a simulated environment, the hole cards including at least two cards; deal, in response to a first wager from at least two player input positions, at least two community cards from the deck; display the at least two community cards to the at least two player input positions on a gaming surface of the simulated environment; deal, in response to a second wager from the at least two player input positions, a final community card from the deck; display the final community card to the at least two player input positions on the gaming surface of the simulated environment; determine, in response to a third wager from each remaining player input position, a winning player hand based on a ranking of a player hand of each remaining player input position, each player hand corresponding to a combination of cards from the hole cards and the community cards; and provide the player input position associated with the winning hand a payout, the payout being based on at least one of the first wager, the second wager, and the third wager.

In some embodiments, each player input position corresponding to a user interface in electronic communication with the system.

In some embodiments, one of the player input positions corresponding to the dealer.

In some embodiments, the hole cards of a given player input position is displayed on the corresponding user interface of the given player input position, and the hole cards of the given player input position is concealed on the corresponding user interfaces of the other player input positions until the winning hand is determined.

In some embodiments, determining the winning player hand based on a ranking of the player hand of each remaining player input position further includes display the hole cards of each remaining player input position, the hole cards of each remaining player input position is displayed on the simulated gaming surface.

In some embodiments, the hole cards of each player input position includes four cards from the deck.

In some embodiments, the player hand of each player input position includes a first hand, the first hand corresponding to a first set of cards having a highest rank based on one or more rules.

In some embodiments, the player hand of each player input position further includes a second hand, the second hand corresponding to a second set of cards having a lowest rank based on the one or more rules.

In some embodiments, the player hand of each player input position includes two hole cards, and wherein a remainder of the player hand includes the community cards.

In some embodiments, the player hand includes two, three, or four of the hole cards, and wherein a remainder of the player hand includes the community cards.

All prior patents and publications referenced herein are incorporated by reference in their entireties.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though it may. Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

As used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “between” does not necessarily require being disposed directly next to other elements. Generally, this term means a configuration where something is sandwiched by two or more other things. At the same time, the term “between” can describe something that is directly next to two opposing things.

Accordingly, in any one or more of the embodiments disclosed herein, a particular structural component being disposed between two other structural elements can be: disposed directly between both of the two other structural elements such that the particular structural component is in direct contact with both of the two other structural elements; disposed directly next to only one of the two other structural elements such that the particular structural component is in direct contact with only one of the two other structural elements; disposed indirectly next to only one of the two other structural elements such that the particular structural component is not in direct contact with only one of the two other structural elements, and there is another element which juxtaposes the particular structural component and the one of the two other structural elements; disposed indirectly between both of the two other structural elements such that the particular structural component is not in direct contact with both of the two other structural elements, and other features can be disposed therebetween; or any combination(s) thereof.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various presently disclosed embodiments. It should be borne in mind, however, that these terms are to be interpreted as referencing physical manipulations and quantities and are merely convenient labels that should be interpreted further in view of terms commonly used in the art. Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

What is claimed is:

1. A system for orchestrating a simulated card game, the system comprising:
a processor; and
a non-transitory computer readable media having stored therein instructions executable by the processor to perform operations comprising:
deal hole cards from a deck of playing cards to each player input position in a simulated environment, the hole cards comprising at least two cards;
deal, in response to a first electronic wager from at least two player input positions, at least two community cards from the deck;
deal, in response to a second electronic wager from the at least two player input positions, a final community card from the deck;
determine, in response to a third electronic wager from each remaining player input position, a winning player hand based on a ranking of a player hand of each remaining player input position, each player hand corresponding to a combination of cards from the hole cards and the community cards; and
provide the player input position associated with the winning hand a payout, the payout being based on at least one of the first electronic wager, the second electronic wager, and the third electronic wager.

2. The system of claim 1, wherein each player input position corresponding to a user interface in electronic communication with the system.

3. The system of claim 2, wherein the hole cards of a given player input position is displayed on the corresponding user interface of the given player input position, and
wherein the hole cards of the given player input position is concealed on the corresponding user interfaces of the other player input positions until the winning hand is determined.

4. The system of claim 1, wherein the deck of playing cards is in a random arrangement.

5. The system of claim 1, the operations further comprising:
display the at least two community cards; and
display the final community card,
wherein each of the community cards is displayed on a simulated gaming surface to the at least two player input positions participating in the card game.

6. The system of claim 5, wherein determining the winning player hand based on the ranking of the player hand of each remaining player input position further comprises:
display the hole cards of each remaining player input position,
wherein the hole cards of each remaining player input position is displayed on the simulated gaming surface.

7. The system of claim 5, wherein the simulated gaming surface further comprises:
a betting area associated with each player input position.

8. The system of claim 1, wherein the hole cards of each player input position comprises two cards, and
wherein the player hand of each player input position comprises the hole cards of the respective player input position and the community cards.

9. The system of claim 1, wherein the hole cards of each player input position comprises four cards, and
wherein the player hand of each player input position comprises a first hand, the first hand corresponding to a first set of cards having a highest rank based on one or more rules.

10. The system of claim 9, wherein the player hand of each player input position further comprises a second hand, the second hand corresponding to a second set of cards having a lowest rank based on the one or more rules.

11. The system of claim 10, wherein the player hand of each player input position comprises two hole cards, and wherein a remainder of the player hand comprises the community cards.

12. The system of claim 10, wherein the player hand includes two, three, or four of the hole cards, and wherein a remainder of the player hand comprises the community cards.

13. A method for conducting a card game in an electronic gaming system, the method comprising:
obtaining, by the electronic gaming system, a deck of playing cards in a randomly shuffled arrangement;
dealing, by the electronic gaming system, hole cards from a deck of playing cards to each player input position in a simulated environment, the hole cards comprising two cards from the deck;
dealing, by the electronic gaming system in response to a first wager from at least two player input positions, at least two community cards from the deck;
dealing, by the electronic gaming system in response to a second wager from the at least two player input positions, a final community card from the deck;
determining, by the electronic gaming system in response to a third wager from each remaining player input position, a winning player hand based on a ranking of a player hand of each remaining player input position, each player hand corresponding to a combination of cards from the hole cards and the community cards; and
providing, by the gaming system, the player input position associated with the winning hand a payout, the payout being based on at least one of the first wager, the second wager, and the third wager.

14. The method of claim 13, further comprising:
display the at least two community cards to the at least two player input positions; and
display the final community card to the at least two player input positions,
wherein each of the community cards is displayed on a simulated gaming surface to the at least two player input positions participating in the card game.

15. The method of claim 14, wherein determining the winning player hand based on the ranking of the player hand of each remaining player input position further comprises:
display the hole cards of each remaining player input position,
wherein the hole cards of each remaining player input position is displayed on the simulated gaming surface.

16. The method of claim 13, wherein the hole cards dealt to each player input position comprises four cards from the deck.

17. The method of claim 16, wherein determining the winning player hand based on the ranking of the player hand of each remaining player input position further comprising:
determine a first hand for each remaining player input position, the first hand corresponding to a first set of cards having a highest rank based on one or more rules.

18. The method of claim 17, wherein determining the winning player hand based on the ranking of the player hand of each remaining player input position further comprising:
determine a second hand for each remaining player input position, the first hand corresponding to a second set of cards having a lowest rank based on the one or more rules.

19. The method of claim 16, wherein the player hand of each player input position comprises two hole cards, and wherein a remainder of the player hand of each player input position comprises the community cards.

20. The method of claim 16, wherein the player hand of each player input position comprises two, three, or four of the hole cards, and wherein a remainder of the player hand of each player input position comprises the community cards.
